(19) United States
(12) Patent Application Publication
(10) Pub. No.: US 2017/0168356 A1
(43) Pub. Date: Jun. 15, 2017

(54) DISPLAY PANEL, DISPLAY DEVICE HAVING THE SAME, AND METHOD THEREOF

(71) Applicants: BOE TECHNOLOGY GROUP CO., LTD., Beijing (CN); Chengdu BOE Optoelectronics Technology Co., Ltd., Chengdu (CN)

(72) Inventors: Falu Yang, Beijing (CN); Junrui Zhang, Beijing (CN)

(73) Assignees: BOE TECHNOLOGY GROUP CO., LTD., Beijing (CN); Chengdu BOE Optoelectronics Technology Co., Ltd., Chengdu (CN)

(21) Appl. No.: 15/038,340

(22) PCT Filed: Dec. 10, 2015
(86) PCT No.: PCT/CN2015/096930

§ 371 Date: May 20, 2016

(30) Foreign Application Priority Data
Jun. 19, 2015 (CN) 201510347512.X

(51) Int. Cl. G02F 1/1343; G02F 1/1333; G02F 1/1335; G06F 3/041

(52) U.S. Cl. CPC G02F 1/134309; G06F 3/0418; G02F 1/13338; G02F 1/133528; G02F 1/13439; G02F 2202/28; G02F 2001/133388; G02F 2201/122; G02F 2202/22; G02F 2201/503

(57) ABSTRACT

The present disclosure provides a display panel comprising an array substrate; a counter substrate spaced apart and facing the array substrate; an upper polarizer located at an outer side of the counter substrate, which side is distal from the array substrate; an electrode pattern layer between the counter substrate and the upper polarizer; wherein the electrode pattern layer is on the counter substrate and connected to ground through an electrically conductive tape; and an electrically conductive adhesive layer between the upper polarizer and the electrode pattern layer.

### CROSS-REFERENCE TO RELATED APPLICATION

This application claims priority to Chinese Patent Application No. 201510347512.X, filed Jun. 19, 2015, the contents of which are incorporated by reference in the entirety.

### FIELD

The present invention relates to display technology, specifically, a display panel and manufacturing method thereof, and a display device.

### BACKGROUND

FIG. 1 shows a cross-sectional view of a conventional integrated full in-cell touch control display panel. The display panel comprises a counter substrate 1, an array substrate 2, liquid crystal 3, sealant 4 and a pair of polarizers 51 and 52. The counter substrate is a substrate spaced apart and facing the array substrate. Typically the counter substrate is a color filter substrate. The array substrate comprises touch electrodes 21 and 22. The polarizers in the display panel include an upper polarizer 51 and a lower polarizer 52. Electrodes are only disposed in the array substrate 2, i.e., the counter substrate 1 does not contain any metal electrode. Thus, static is easily produced when the display panel is in use. FIG. 2 shows a conventional anti-static method wherein an anti-static coating 511 is included on the surface of the upper polarizer 51. The anti-static coating 511 adheres to the upper surface of the counter substrate 1 through an adhesive layer 512. Because the anti-static coating 511 is exposed on the outmost surface of the display panel, it is susceptible to abrasion or scuffing. As a result, the anti-static function of the anti-static layer is affected, and the touch control may become unstable.

### SUMMARY

In one aspect, the present invention provides a display panel, comprising an array substrate, a counter substrate facing the array substrate, and an upper polarizer located at one side of the counter substrate, which side is distal from the array substrate, wherein the counter substrate has an electrode pattern layer on its surface facing the upper polarizer, the electrode pattern layer is connected to the ground of the array substrate through an electrically conductive tape (e.g., an electrically conductive adhesive tape), and an electrically conductive adhesive layer is formed between the upper polarizer and the electrode pattern layer.

Optionally, the electrode pattern layer is located within a non-display region of the display panel.

Optionally, the electrode pattern layer is a metal layer.

Optionally, the material of the electrode pattern layer is selected from the group consisting of the following or combination thereof: copper, molybdenum, indium-tin oxide, graphene, and nano-silver.

Optionally, the pattern of the electrode pattern layer comprises a closed pattern.

Optionally, the electrode pattern layer comprises two strip electrodes connected together by the electrically conductive tape (e.g., an electrically conductive tape).

Optionally, the electrically conductive adhesive layer comprises adhesive and electrically conductive particles adhered to the adhesive.

Optionally, the surface resistivity of the electrically conductive adhesive layer is 10⁵˜10¹²Ω.

In a second aspect, the present invention, it provides a method of manufacturing display panel, comprising:

(a) forming a pattern comprising an electrode pattern layer on the surface of a counter substrate;

(b) forming a pattern comprising an electrically conductive tape (e.g., an electrically conductive tape), wherein the electrically conductive tape connects the electrode pattern layer to the ground of an array substrate when the array substrate and the counter substrate are assembled together to form a cell;

(c) forming an electrically conductive adhesive layer by disposing electrically conductive particles into an adhesive layer on the upper polarizer; and

(d) adhering the upper polarizer, through the electrically conductive adhesive layer, to the surface of the counter substrate comprising the electrode pattern layer.

Optionally, the pattern comprising the electrode pattern layer in step (a) is formed by a mask process.

Optionally, the pattern comprising the electrode pattern layer in step (a) is formed by spiral coating, strand coating, or screen printing.

Optionally, the electrically conductive tape in step (b) is formed by adhering a solid electrically conductive adhesive, or by coating and solidifying a liquid electrically conductive.

In another aspect, the present invention provides a display panel comprising an array substrate; a counter substrate spaced apart from the array substrate and facing the array substrate, the counter substrate having an outer side distal from the array substrate; a polarizer having an inner surface facing the outer side of the counter substrate; an electrically conductive adhesive layer on the inner surface of the polarizer; and a grounding structure for connecting the electrically conductive adhesive layer to ground. Optionally, the grounding structure comprises an electrically conductive tape disposed on the outer side of the counter substrate. Optionally, the grounding structure further comprises an electrode pattern layer disposed on the outer side of the counter substrate; the electrode pattern layer is connected to ground via the electrically conductive tape. Optionally, the electrode pattern layer is located within a non-display region of the display panel. Optionally, the electrode pattern layer is a metal layer. Optionally, the material of the electrode pattern layer is selected from the group consisting of the following or combination thereof: copper, molybdenum, indium-tin oxide, graphene, and nano-silver. Optionally, the pattern of the electrode pattern layer comprises a closed pattern. Optionally, the electrode pattern layer comprises two strip electrodes connected together by the electrically conductive tape. Optionally, the electrically conductive adhesive layer is connected to the ground of the array substrate. Optionally, the electrically conductive tape is an electrically conductive adhesive tape. Optionally, the electrically conductive adhesive layer comprises adhesive and electrically conductive particles adhered to the adhesive. Optionally, the surface resistivity of the electrically conductive adhesive layer is 10⁵˜10¹²Ω.

In another aspect, the present invention provides a method of manufacturing display panel, comprising forming an electrically conductive adhesive layer on a polarizer; forming a grounding structure for connecting the electrically conductive adhesive layer to ground; and adhering the polarizer, through the electrically conductive adhesive layer, to the surface of the counter substrate comprising the electrode pattern layer. Optionally, the grounding structure comprises an electrically conductive tape disposed on the outer side of the counter substrate. Optionally, the step of forming a grounding structure comprises forming and/or patterning an electrically conductive tape. Optionally, the grounding structure further comprises an electrode pattern layer disposed on the outer side of the counter substrate; the electrode pattern layer is connected to ground via the electrically conductive tape. Optionally, the method further comprises forming and/or patterning an electrode pattern layer on the outer side of the counter substrate. Optionally, the electrode pattern layer is formed by a mask process. Optionally, the electrode pattern layer is formed by spiral coating, strand coating, or screen printing. Optionally, the electrically conductive adhesive layer is formed by disposing electrically conductive particles into an adhesive layer on the upper polarizer. Optionally, the electrically conductive tape is formed by adhering a solid electrically conductive adhesive, or by coating and solidifying a liquid electrically conductive. Optionally, the electrically conductive adhesive layer is connected to the ground of array substrate. Optionally, the electrically conductive tape is an electrically conductive adhesive tape.

In another aspect, the present invention provides a display panel manufactured according to the method of the present disclosure.

### BRIEF DESCRIPTION OF THE FIGURES

The following drawings are merely examples for illustrative purposes according to various disclosed embodiments and are not intended to limit the scope of the present disclosure.

FIG. 1 shows a cross-sectional view of a conventional display panel.

FIG. 2 shows a diagram of the layered structure in the display panel of FIG. 1 having an upper polarizer 51, an anti-static coating 511, and an adhesive layer 512.

FIG. 3 shows a cross-sectional view of an exemplary display panel of the present disclosure.

FIG. 4 is a diagram illustrating one exemplary design of an electrode pattern layer in the display panel of FIG. 3.

FIG. 5 is a diagram illustrating another exemplary design of an electrode pattern layer in the display panel of FIG. 3.

FIG. 6 shows a diagram of the layered structure of the display panel of FIG. 3 having an upper polarizer 53 and an electrically conductive adhesive layer 531.

FIG. 7 is a diagram illustrating an exemplary electrically conductive adhesive layer 531 in the display panel of FIG. 3.

FIG. 8 is a flow chart illustrating a method of manufacturing display panel according to an exemplary embodiment of the present disclosure.

FIG. 9 is a flow chart illustrating a method of manufacturing display panel according to another exemplary embodiment of the present disclosure.

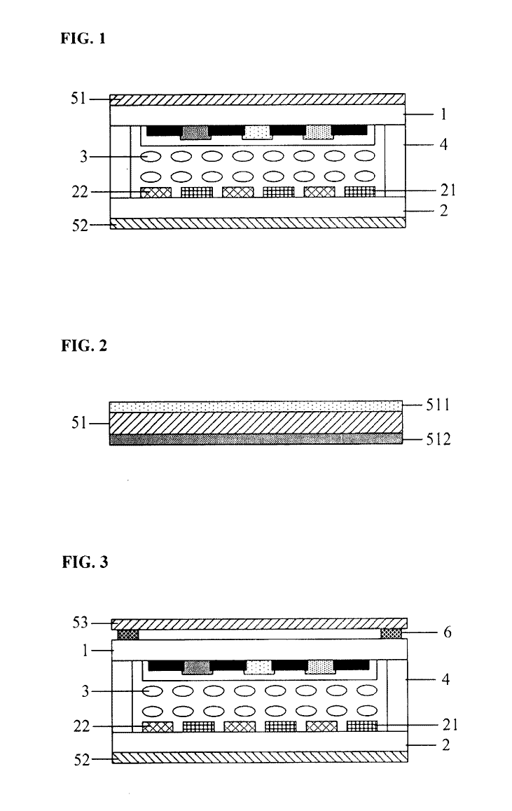

### DETAILED DESCRIPTION OF THE EMBODIMENTS

The display panel of the present invention includes an anti-static structure formed between the upper polarizer and the counter substrate. The anti-static structure comprises an electrode pattern layer, an electrically conductive adhesive layer and an electrically conductive tape (e.g., an electrically conductive tape). The existing technology uses an anti-static layer as the outmost coating of the display panel. The anti-static function of the anti-static layer may be affected by abrasion or scuffing. The present invention avoids this problem, thereby achieving stable touch control and anti-static effects.

Illustrative embodiments of the present disclosure will now be described in detail with reference to the accompanying drawings. It is to be understood that these illustrative embodiments do not limit the scope of the invention, but merely serve to clarify the invention.

In an exemplary embodiment, the present disclosure provides a display panel comprising an array substrate, a counter substrate spaced apart from the array substrate and facing the array substrate, the counter substrate having an outer side distal from the array substrate, a polarizer having an inner surface facing the outer side of the counter substrate, an electrically conductive adhesive layer on the inner surface of the polarizer; and a grounding structure for connecting the electrically conductive adhesive layer to ground.

The grounding structure can be of any electrically conductive material, such as a metal, a conductive adhesive, or a conductive plastic. The grounding structure can be of any shape or dimension, such as a block, a wire, or a line, as long as it connects the electrically conductive adhesive layer to ground. One example of the grounding structure is an electrically conductive tape disposed on the outer side of the counter substrate, and contacting the electrically conductive adhesive layer. The grounding structure can further include an electrical conductive layer disposed between the counter substrate and the upper polarizer. For example, the grounding structure can comprise an electrode pattern layer disposed on the outer side of the counter substrate. The electrode pattern layer can be connected to ground via the electrically conductive tape or wire.

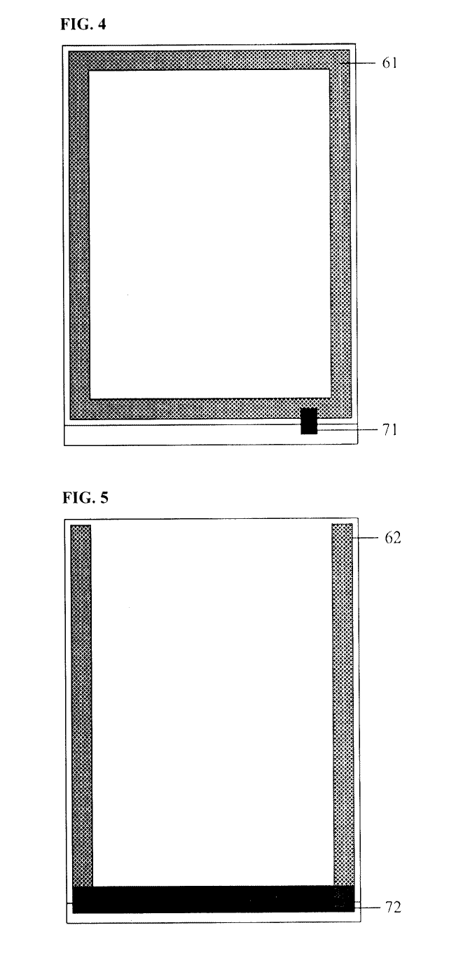

As shown in FIGS. 3-7, in some embodiments, the display panel comprises: an array substrate 2, a counter substrate 1 spaced apart from the array substrate 2 and facing the array substrate 2, a lower polarizer 52, and an upper polarizer 53. The upper polarizer 53 is located at an outer side of the counter substrate 1, which side is distal from the array substrate 2. The lower polarizer 52 is located at an outer side of the array substrate 2, which side is distal from the counter substrate 1. The array substrate 2 comprises touch electrodes 21 and 22. The array substrate 2 and the counter substrate 1 are assembled together with sealant 4 to seal liquid crystal 3 inside, thereby forming a display panel. The counter substrate 1 has an electrode pattern layer 6 on its surface facing the upper polarizer 53 to achieve anti-static effects. The electrode pattern layer 6 is connected to ground, e.g., ground of an array substrate 2. shown in FIG, 6, the upper polarizer 53 has an electrically conductive adhesive layer 531 on its surface facing the electrode pattern layer 6. If static electricity is produced during touch control in a display panel, electrostatic charge is conducted through the electrically conductive adhesive layer 531 to the electrode pattern layer 6, then flows through an electrically conductive tape (e.g., an electrically conductive tape) to the ground of array substrate 2, thereby achieving anti-static effects in a touch control display panel. In addition, any static electricity produced within the display panel can be conducted through the electrode pattern layer 6 and the electricity conductive tape to ground. Because every anti-static layer is disposed inside the display panel, the anti-static function of the anti-static layer are not affected by abrasion or scuffing. The display panel of the present disclosure therefore achieves stable touch control and excellent anti-static effects.

The electrode pattern layer 6 can be disposed in a display region or a non-display region on the counter substrate. Preferably, the electrode pattern layer 6 is disposed in a non-display region. A display region is a region for display images, e.g., comprising a plurality of pixels for displaying images.

The electrode pattern layer 6 can be a transparent electrode or a non-transparent electrode. A transparent electrode can be disposed in any area of the counter substrate 1. If the electrode pattern layer is disposed in an area corresponding to a display region on the counter substrate, touch control function of the display panel may be affected. Thus the electrode pattern layer 6 is optionally disposed in a non-display region, e.g., along the edges of the display panel.

Further, the electrode pattern layer 6 can optionally be a metal electrode pattern layer, i.e., made of metal material. Due to the high electric conductivity of metal material, better anti-static effects can be achieved by using a metal electrode pattern layer. Metals are non-transparent material, optionally a metal electrode pattern layer is disposed in a non-display region of the display panel.

Optionally, the material of the electrode pattern layer 6 can be selected from the group consisting of the following or combination thereof copper, molybdenum, indium-tin oxide, graphene, and nano-silver, Any other suitable material can be utilized as the material for making electrode pattern layer 6.

The electrode pattern layer 6 can be of any shape. As shown in FIG. 4, the electrode pattern layer 6 can optionally comprise a closed rectangular electrode disposed in the non-display region, connected to ground of array substrate 2 through the electrically conductive tape 71 (e.g., an electrically conductive tape). The pattern of the electrode pattern layer 6 can comprise a non closed pattern. As shown in FIG. 5, the electrode pattern layer 6 can optionally comprise two strip electrodes 62 connected together by an oblong electrically conductive tape 72 (e.g., an electrically conductive tape), and in turn connected to the ground of the array substrate 2 through the electrically conductive tape 72 (e.g., an electrically conductive tape).

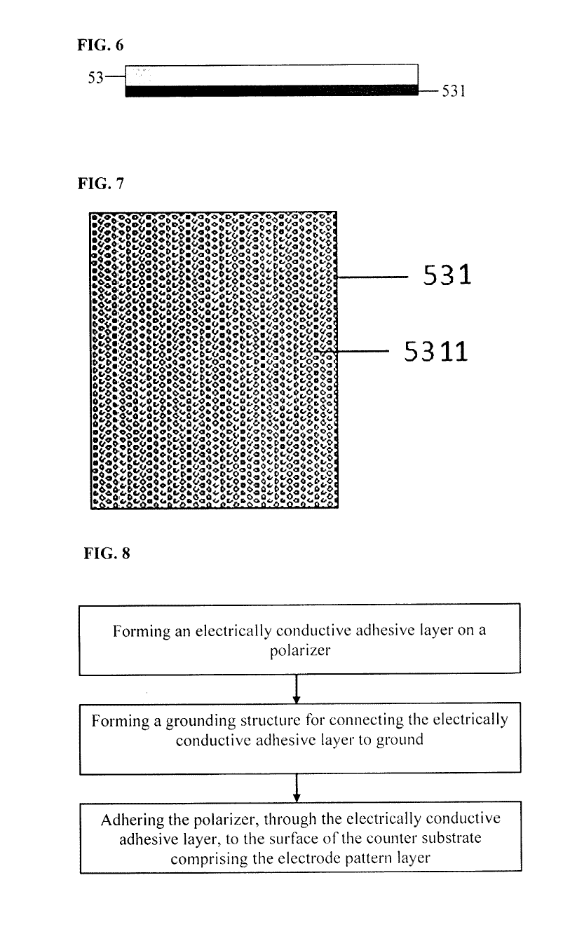

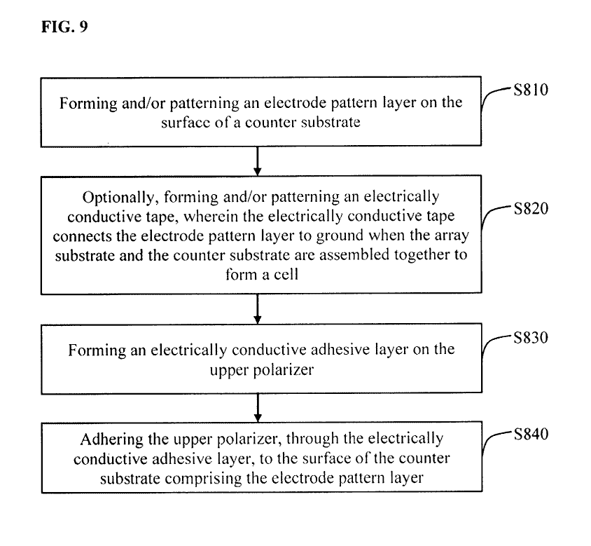

As shown in FIG. 7, optionally the electrically conductive adhesive layer 531 comprises an adhesive and electrically conductive particles 5311 adhered to the adhesive. Optionally, the surface resistivity of the electrically conductive adhesive layer 531 is 10⁵˜10¹²Ω, having relatively good electrical conductivity. In some embodiments, the upper polarizer 53 itself comprises an adhesive, thus it is not necessary to prepare a layer of adhesive ab initio. Accordingly, the electrically conductive adhesive layer 531 can be prepared by adding electrically conductive particles 5311 into the adhesive of the upper polarizer 53. In some embodiments, the upper polarizer 53 itself does not comprise an adhesive, thus it is necessary to form an electrically conductive adhesive layer 531 ab initio. For example, the electrically conductive adhesive layer 531 can be formed by applying a premade electrically conductive adhesive material on the surface of the upper polarizer 53. The electrically conductive adhesive layer can cover both the display region and the non-display region of the counter substrate. In some embodiments, the electrically conductive adhesive layer covers only the display region. Optionally, the electrically conductive adhesive layer covers the entire surface of upper polarizer 53. In some embodiments, the upper polarizer further comprises a tri-acetate cellulose layer.

The present disclosure also provides a method of manufacturing display panel. A non-limiting, illustrative embodiment is shown in FIG. 8. Referring to FIG. 8, the method of the embodiment comprises forming an electrically conductive adhesive layer on a polarizer; forming a grounding structure for connecting the electrically conductive adhesive layer to ground; and adhering the polarizer, through the electrically conductive adhesive layer, to the surface of the counter substrate comprising the electrode pattern layer. It should be understood that these steps are not necessarily performed sequentially, and in general can be performed in parallel with each other wherever possible.

As discussed above, the grounding structure can comprise an electrically conductive tape disposed on the outer side of the counter substrate, and can further comprise an electrode pattern layer disposed on the outer side of the counter substrate; the electrode pattern layer is connected to ground via the electrically conductive tape. Accordingly, the step of forming a grounding structure can comprise forming and/or patterning an electrically conductive tape. The method of the embodiment can further comprise forming and/or patterning an electrode pattern layer on the outer side of the counter substrate. The electrode pattern layer can be formed using any suitable process, for example, a mask process, spiral coating, strand coating, or screen printing. The electrically conductive adhesive layer can be formed by any suitable method, for example, by disposing electrically conductive particles into an adhesive layer on the upper polarizer, or by adhering a solid electrically conductive adhesive, or by coating and solidifying a liquid electrically conductive.

A non-limiting, illustrative embodiment is shown in FIG. 9. Referring to FIG. 9, the method of the embodiment comprises:

step S810, forming and/or patterning an electrode pattern layer on the surface of a counter substrate, wherein the electrode pattern layer is connected to ground;

step S830, forming an electrically conductive adhesive layer on the upper polarizer; and

step S840, adhering the upper polarizer, through the electrically conductive adhesive layer, to the surface of the counter substrate comprising the electrode pattern layer.

Optionally, the method further comprising:

step S820, forming and/or patterning an electrically conductive tape, wherein the electrically conductive tape connects the electrode pattern layer to ground when the array substrate and the counter substrate are assembled together to form a cell.

Optionally, in step S820, the electrically conductive adhesive layer is formed by disposing electrically conductive particles into an adhesive layer on the upper polarizer.

Optionally, in step S820, the electrically conductive adhesive tape connects the electrode pattern layer to the ground of an array substrate when the array substrate and the counter substrate are assembled together to form a cell.

It should be understood that the steps S810-S840 or sub-steps thereof are not necessarily performed sequentially, and in general can be performed in parallel with each other wherever possible. For example, S810 and S830 can be performed in parallel.

Optionally, the pattern comprising the electrode pattern layer in step S810 is formed by a mask process.

Optionally, the pattern comprising the electrode pattern layer in step S810 is formed by spiral coating, strand coating, or screen printing.

Optionally, the electrically conductive tape in step S820 is formed by adhering a solid electrically conductive adhesive, or by coating and solidifying a liquid electrically conductive.

Optionally, in step S830, the upper polarizer itself comprises adhesive, therefore it is not necessary to prepare a layer of adhesive ab initio. The electrically conductive adhesive layer 531 may be prepared by adding electrically conductive particles S311 into the adhesive of the upper polarizer.

In the specific, non-limiting examples herein, the electrode pattern layer is shown to be connected to a ground of the array substrate. Optionally, the electrode pattern layer suitable for the display panels and methods of the present disclosure can be connected to any suitable ground, i.e., a portion having a ground voltage, directly or indirectly. Optionally, the electrode pattern layer can be connected to a supporting structure of the display panel, e.g., a frame.

Any suitable material can be utilized for preparing an electrically conductive adhesive layer. For example, the material can be silver epoxy conductive adhesive, copper epoxy conductive adhesive, and other suitable metal conductive adhesives, Optionally, the electrically conductive adhesive is prepared by mixing metal particles with an adhesive. Optionally, the metal particles can be prepared in form of nano-particles. Optionally, the electrically conductive adhesive layer can be an electrically conductive adhesive film.

In the specific, non-limiting examples above, a surface resistivity of the electrically conductive adhesive layer 531 ranging from 10⁵ to 10¹²Ω is used. Optionally, any suitable electrically conductive adhesive layer 531 having relatively good electrical conductivity can be used in the display panels and methods of the present disclosure. Optionally, the electrically conductive adhesive layer 531 can have a surface resistivity ranging from 10⁵ to 10¹²Ω, e.g., 10⁵ to 10⁶Ω, 10⁶ to 10⁷Ω, 10⁷ to 10⁸Ω, 10⁸ to 10⁹Ω, 10⁹ to 10¹⁰Ω, 10¹⁰ to 10¹¹Ω, 10¹¹ to 10¹²Ω, 10⁵ to 10⁸Ω, or 10⁸ to 10¹²Ω. Optionally, the electrically conductive adhesive layer 531 can have a volume resistivity ranging from 10⁴ to 10¹¹ Ωcm, e.g., 10⁴ to 10⁵ Ωcm , 10⁵ to 10⁶ Ωcm, 10⁶ to 10⁷ Ωcm, 10⁷ to 10⁸ Ωcm, 10⁸ to 10⁹ Ωcm, 10⁹ to 10¹⁰ Ωcm, 10¹⁰ to 10¹¹ Ωcm, 10⁴ to 10⁷ Ωcm, or 10⁷ to 10¹¹ Ωcm. The term “volume resistivity” refers to a value (thin) that is obtained by dividing the intensity of a direct-current electric field generated in a measurement target by a current density that is in a stationary state. The term “surface resistivity” refers to a value (Ω) that is obtained by dividing the intensity of a direct-current electric field generated in a surface layer of a measurement target by a current per unit length of an electrode. Measurement methods are defined, for example, in JIS standard C213.

Any suitable material can be utilized for preparing an electrically conductive tape. For example, the material can be a metal such as Aluminum, Silver, or Gold. Optionally, the material can be a conductive or dissipative material. Optionally, the electrically conductive tape can be an electrically conductive adhesive tape prepared using an electrically conductive adhesive material. Optionally, the electrically conductive adhesive tape can have any suitable shape and dimension, e.g., a block, a wire, a line, etc. Optionally, the electrically conductive adhesive tape can be prepared by a patterning process.

The above embodiments are only used to explain the present invention, and should not be construed to limit the present invention. It will be understood by those skilled in the art that various changes and modifications may be made therein without departing from the spirit of the present invention, the scope of which is defined in the appended claims and their equivalents.

1. A display panel comprising:
an array substrate;
a counter substrate spaced apart from the array substrate and facing the array substrate, the counter substrate having an outer side distal from the array substrate;
a polarizer having an inner surface facing the outer side of the counter substrate;
an electrically conductive adhesive layer on the inner surface of the polarizer; and
a grounding structure for connecting the electrically conductive adhesive layer to ground.

2. The display panel according to claim 1, wherein the grounding structure comprises an electrically conductive tape disposed on the outer side of the counter substrate.

3. The display panel according to claim 2, wherein the grounding structure further comprises an electrode pattern layer disposed on the outer side of the counter substrate; the electrode pattern layer is connected to ground via the electrically conductive tape.

4. The display panel according to claim 3, wherein the electrode pattern layer is located within a non-display region of the display panel.

5. The display panel according to claim 4, wherein the electrode pattern layer is a metal layer.

6. The display panel according to claim 4, wherein the material of the electrode pattern layer is selected from the group consisting of the following or combination thereof: copper, molybdenum, indium-tin oxide, graphene, and nano-silver.

7. The display panel according to claim 3, wherein the pattern of the electrode pattern layer comprises a closed pattern.

8. The display panel according to claim 3, wherein the electrode pattern layer comprises two strip electrodes connected together by the electrically conductive tape.

9. (canceled)

10. The display panel according to claim 2, wherein the electrically conductive tape is an electrically conductive adhesive tape.

11. The display panel according to claim 1, wherein the electrically conductive adhesive layer comprises adhesive and electrically conductive particles adhered to the adhesive.

12. The display panel according to claim 1, wherein the surface resistivity of the electrically conductive adhesive layer is 10⁵˜10¹²Ω.

13. A method of manufacturing display panel, comprising:
forming an electrically conductive adhesive layer on a polarizer;
forming a grounding structure for connecting the electrically conductive adhesive layer to ground; and
adhering the polarizer, through the electrically conductive adhesive layer, to the surface of the counter substrate comprising the electrode pattern layer.

14. The method of manufacturing display panel according to claim 13, wherein the grounding structure comprises an electrically conductive tape disposed on the outer side of the counter substrate.

15. The method of manufacturing display panel according to claim 14, the step of forming a grounding structure comprises forming and/or patterning an electrically conductive tape.

16. The method of manufacturing display panel according to claim 14, wherein the grounding structure further comprises an electrode pattern layer disposed on the outer side of the counter substrate; the electrode pattern layer is connected to ground via the electrically conductive tape.

17. The method of manufacturing display panel according to claim 16, further comprising
forming and/or patterning an electrode pattern layer on the outer side of the counter substrate.

18. The method of manufacturing display panel according to claim 17, wherein the electrode pattern layer is formed by a mask process, spiral coating, strand coating, or screen printing.

19. (canceled)

20. The method of manufacturing display panel according to claim 13, wherein the electrically conductive adhesive layer is formed by disposing electrically conductive particles into an adhesive layer on the upper polarizer, or adhering a solid electrically conductive adhesive, or by coating and solidifying a liquid electrically conductive.

21. (canceled)

22. (canceled)

23. The method of manufacturing display panel according to claim 14, wherein the electrically conductive tape is an electrically conductive adhesive tape.

24. A display panel manufactured according to the method according to claim 13.
